(19) United States
(12) Patent Application Publication
(10) Pub. No.: US 2026/0106640 A1
(43) Pub. Date: Apr. 16, 2026

(54) ELECTRONIC DEVICE PROTECTIVE CASE FOR FOLDABLE ELECTRONIC DEVICE

(71) Applicant: SHENZHEN EARY INNOVATION DESIGN CO., LTD, SHENZHEN (CN)

(72) Inventor: Shiwang Zhou, SHENZHEN (CN)

(21) Appl. No.: 19/356,074

(22) Filed: Oct. 11, 2025

(30) Foreign Application Priority Data
Oct. 12, 2024 (CN) 202422464682.3
Aug. 28, 2025 (CN) 202521852374.6

(51) Int. Cl. H04B 1/3888; A45C 11/00; H04M 1/02

(52) U.S. Cl. CPC H04B 1/3888; A45C 11/002; H04M 1/0216

(57) ABSTRACT

This application relates to an electronic device protective case for a foldable electronic device, including at least two protective cases, with a connecting middle case disposed between two adjacent protective cases. The connecting middle case includes a base plate and two clamping arms; the base plate and the two clamping arms enclose a clamping space for clamping the two protective cases; two sides of each of the two protective cases are respectively provided with side walls cooperatively connected with the two clamping arms; and on two opposite side surfaces of the side wall and the clamping arm, one surface is convexly provided with a rotating shaft.

### CROSS REFERENCE TO RELATED APPLICATIONS

The present application claims the benefit of Chinese Patent Application No. 202422464682.3 filed on Oct. 12, 2024 and 202521852374.6 filed on Aug. 28, 2025. All the above are hereby incorporated by reference in their entirety.

### FIELD OF TECHNOLOGY

This application relates to the technical field of electronic device accessories, and more specifically, to an electronic device protective case for a foldable electronic device.

### BACKGROUND

A foldable screen phone is a new type of smartphone that has unique unfolded and folded modes, enabling more flexible usage. To cater to foldable screen phones, foldable phone protective cases have emerged.

A foldable phone protective case has appeared on the market, such as the one disclosed in patent application CN202321298013.2, which includes two casings with a protective member rotatably connected between the two casings. The protective member includes a protective portion and a connecting portion, with extending portions respectively provided at both ends of the protective portion, and the protective portion and the two extending portions form a U-shaped structure. A first connecting hole is provided in a side wall of the casing, and two sets of second connecting holes are provided in the extending portions. The first connecting holes in different casings respectively match the two second connecting holes, and the first connecting holes and the second connecting holes are rotatably connected with two rotation shafts on a connecting middle case. As the protective member is provided, this foldable phone protective case can adapt to changes in the foldable phone and maintain a close fit with the phone's side wall under the action of dual shafts, thus providing better protection for the phone. However, during mounting of this foldable phone protective case, the two casings need to be respectively mounted on the upper and lower ends of the phone, then the protective portion sleeves the two casings, and finally a casing frame is connected to the extending portions of the protective portion through the connecting portion. During detachment, the connecting portion needs to be removed first, followed by the protective portion, before the casings can be removed from the phone, making assembly and disassembly inconvenient.

### SUMMARY

Given the above defects of the prior art, to resolve the related technical problem, this application provides an electronic device protective case for a foldable electronic device.

The technical solution adopted by this application to solve the technical problem is: The electronic device protective case for a foldable electronic device includes at least two protective cases, with a connecting middle case disposed between two adjacent protective cases; where the connecting middle case includes a base plate and two clamping arms; the base plate and the two clamping arms enclose a clamping space for clamping the two protective cases; two sides of each of the two protective cases are respectively provided with side walls cooperatively connected with the two clamping arms; and on two opposite side surfaces of the side wall and the clamping arm, one surface is convexly provided with a rotating shaft, and the other surface is provided with a first groove cooperatively engaged with the rotating shaft.

The first groove corresponding to at least one of the protective cases is an elongated oblique slot, and during a process of the protective case rotating relative to the connecting middle case, the rotating shaft is movable along a length direction of the first groove. Specifically, the first groove is an elongated oblique slot with a top end inclined toward a middle region of the base plate. The top end of the first groove is an end of the first groove away from the base plate, and a first end of the first groove opposite to the top end is a bottom end, the bottom end being an end of the first groove closer to the base plate.

This application also discloses a protective case for a foldable electronic device, including a first protective case, a second protective case, a connecting middle case, a locking assembly, and a first elastic member; an end of the first protective case and an end of the second protective case are both rotatably mounted on the connecting middle case, so that the first protective case and the second protective case are rotatable towards each other for folding; the connecting middle case includes a base plate and a clamping arm, and the clamping arm is mounted at a first end of the base plate and is movable to approach and leave the first end; the first elastic member is connected to both the first end and the clamping arm, and the first elastic member provides an elastic force driving the clamping arm to move in a direction away from the first end; the clamping arm is detachably connected to the first protective case and the second protective case; and the locking assembly is mounted on the connecting middle case and locks the clamping arm; and

The locking assembly is driven to unlock the clamping arm, causing the clamping arm to move in the direction away from the first end under the elastic force of the first elastic member, so that the first protective case and the second protective case are detachable on the connecting middle case after disconnected from the clamping arm.

The beneficial effect of this application is that the electronic device protective case has a simple structure. As the base plate and the two clamping arms enclose a clamping space for clamping the two protective cases, the size of the clamping space can be adjusted by controlling the spacing between the two clamping arms, enabling the two protective cases to be directly inserted into or removed from the connecting middle case. When the two protective cases are fully mounted, the rotating shaft engages with the corresponding first groove to achieve movable positioning, ensuring stable mounting. During the process of the two protective cases folding and rotating relative to the connecting middle case, the rotating shaft rotates within the first groove, enabling flexible rotation. For detachment, the protective cases can be removed from the connecting middle case by adjusting the spacing between the two clamping arms to disengage the rotating shaft from the first groove, making assembly and disassembly simple.

### BRIEF DESCRIPTION OF THE DRAWINGS

To more clearly illustrate the technical solutions in the embodiments of this application or the prior art, the application is further described below with reference to the drawings and embodiments. The drawings described below are only some embodiments of this application, and for those of ordinary skill in the art, other drawings can be obtained based on these drawings without creative effort:

FIG. 1 is a first schematic structural diagram of an electronic device protective case for a foldable electronic device according to a preferred embodiment of this application (a folded state diagram of the electronic device protective case).

FIG. 2 is a second schematic structural diagram of an electronic device protective case for a foldable electronic device according to a preferred embodiment of this application (an unfolded state diagram of the electronic device protective case).

FIG. 3 is an exploded perspective view of the electronic device protective case in FIG. 2.

FIG. 4 is a cross-sectional view along A-A in FIG. 2.

FIG. 5 is a schematic diagram of a protective case according to an embodiment of this utility model.

FIG. 6 is another schematic diagram of the protective case according to an embodiment of this utility model.

FIG. 7 is a schematic diagram of a connecting middle case according to an embodiment of this utility model.

FIG. 8 is a schematic exploded diagram of the connecting middle case according to an embodiment of this utility model.

FIG. 9 is another schematic diagram of the connecting middle case according to an embodiment of this utility model.

FIG. 10 is another schematic diagram of the connecting middle case according to an embodiment of this utility model.

FIG. 11 is a cross-sectional view along A-A in FIG. 10.

FIG. 12 is a schematic diagram of a clamping arm according to an embodiment of this utility model.

FIG. 13 is another schematic diagram of the connecting middle case according to an embodiment of this utility model.

FIG. 14 is a partial enlarged view of portion A in FIG. 5.

FIG. 15 is a partial enlarged view of portion B in FIG. 6.

FIG. 16 is a brief schematic diagram of the connecting middle case according to an embodiment of this utility model.

FIG. 17 is another brief schematic diagram of the connecting middle case according to an embodiment of this utility model.

### DESCRIPTION OF THE EMBODIMENTS

The terms “first,” “second,” “third,” and “fourth” in the specification, claims, and drawings of this application are used to distinguish different objects, rather than to describe a specific order. Additionally, the terms “include” and “have,” as well as any variations thereof, are intended to cover non-exclusive inclusion. For example, a process, method, system, product, or device that includes a series of steps or units is not limited to the listed steps or units, but optionally also includes unlisted steps or units, or optionally includes other steps or units inherent to these processes, methods, products, or devices.

Reference to “embodiment” herein means that a specific feature, structure, or characteristic described in connection with the embodiment may be included in at least one embodiment of this application. The appearance of this phrase in various places in the specification does not necessarily refer to the same embodiment, nor is it an independent or alternative embodiment mutually exclusive with other embodiments. It is explicitly and implicitly understood by those skilled in the art that the embodiments described herein can be combined with other embodiments.

“Multiple” refers to two or more. “And/or” describes the association relationship of associated objects, indicating that three relationships may exist; for example, A and/or B may indicate: A exists alone, A and B exist simultaneously, or B exists alone. The character “/” generally indicates that the associated objects before and after it are in an “or” relationship.

Moreover, terms indicating orientation such as “upper,” “lower,” “front,” “rear,” “left,” “right,” “upper end,” “lower end,” and “longitudinal,” are all referenced to the posture position of the apparatus or device of this solution during normal use.

To make the objectives, technical solutions, and advantages of the embodiments of this application clearer, a clear and complete description is provided below with reference to the technical solutions in the embodiments of this application. The described embodiments are some, but not all, embodiments of this application. Based on the embodiments of this application, all other embodiments obtained by those of ordinary skill in the art without creative effort fall within the protection scope of this application.

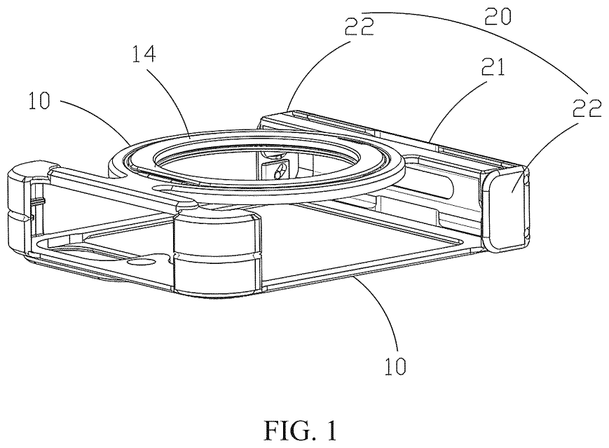

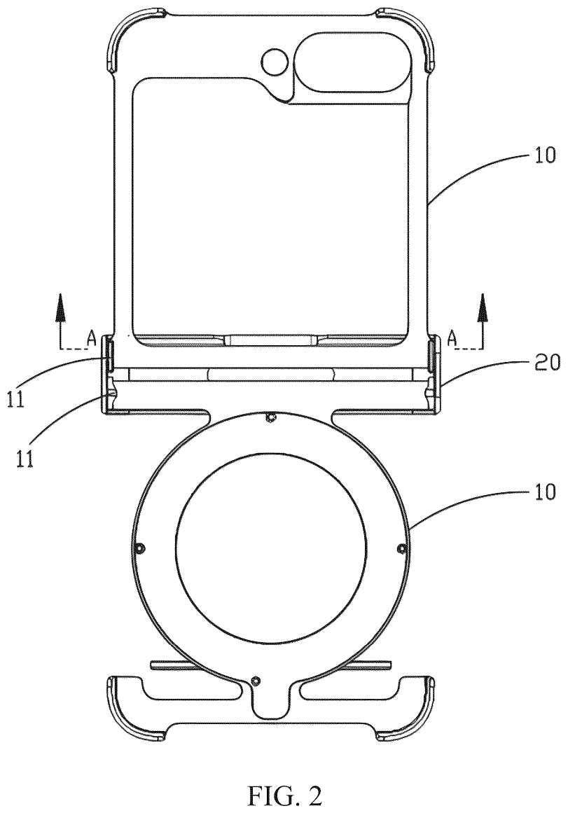

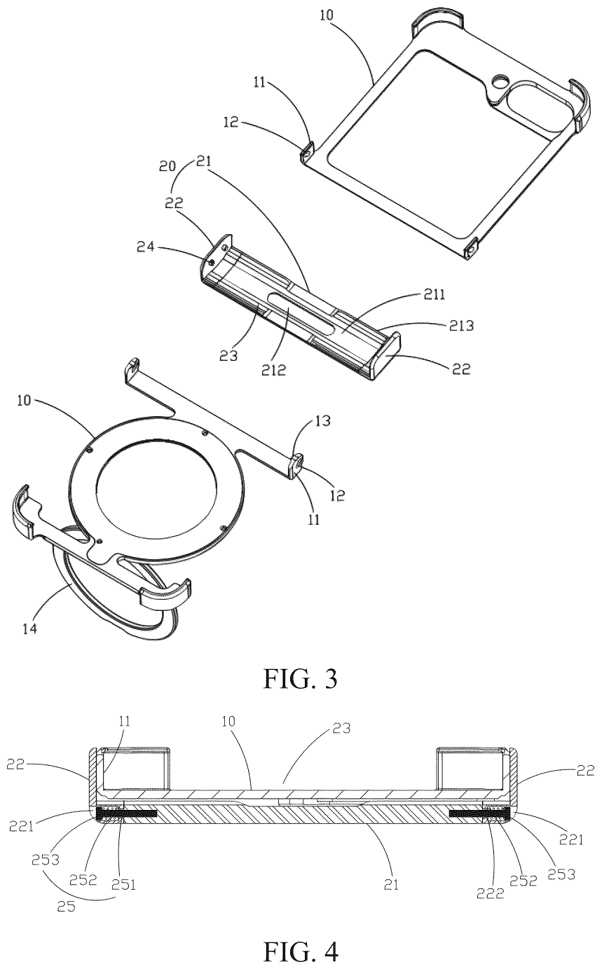

A preferred embodiment of this application provides an electronic device protective case for a foldable electronic device, and the electronic device protective case is a housing designed specifically for various electronic devices to protect the device from collisions, scratches, drops, and dust, effectively safeguarding the device's appearance and internal components and prolonging the service life of the electronic device. The electronic device includes, but is not limited to, mobile phones, tablet computers, laptops, readers, and the like. The embodiments of this application are analyzed and described using a mobile phone protective case as an example. As shown in FIGS. 1 and 2, the folded state diagram and the unfolded state diagram of the electronic device protective case are respectively shown, including at least two protective cases 10, with a connecting middle case 20 disposed between two adjacent protective cases 10, where the connecting middle case 20 includes a base plate 21 and two clamping arms 22. In one embodiment, both clamping arms 22 are movably connected to the base plate 21. Optionally, alternatively, only one clamping arm 22 may be movably connected to the base plate 21; the base plate 21 and the two clamping arms 22 enclose a clamping space 23 for clamping the two protective cases 10; and the spacing between the two clamping arms 22 is adjustable, facilitating the mounting of the protective cases into the clamping space or removal from the clamping space. Two sides of each of the two protective cases 10 are respectively provided with side walls 11 cooperatively connected with the two clamping arms 22. As shown in FIG. 3, in one embodiment, both sides of an inner side surface of the two side walls 11 are symmetrically convexly provided with a rotating shaft 24, and the side walls of the two protective cases 10 are respectively provided with first grooves 12 cooperatively engaged with the two rotating shafts 24. Optionally, the two rotating shafts 24 may also be respectively provided on the side walls of the two protective cases 10, and the two first grooves 12 are provided on both sides of the side wall 11. The above simple positional replacements all fall within the protection scope of this application.

The electronic device protective case has a simple structure. As the base plate and the two clamping arms enclose a clamping space for clamping the two protective cases, the size of the clamping space can be adjusted by controlling the spacing between the two clamping arms, enabling the two protective cases to be directly inserted into the connecting middle case or removed from the connecting middle case. When the two protective cases are fully mounted, the rotating shaft engages with the corresponding first groove to achieve movable positioning, ensuring stable mounting. During the process of the two protective cases folding and rotating relative to the connecting middle case, the rotating shaft rotates within the first groove, enabling flexible rotation. For detachment, the protective cases can be removed from the connecting middle case by adjusting the spacing between the two clamping arms to disengage the rotating shaft from the first groove, making assembly and disassembly simple.

In this embodiment, the electronic device protective case has a folded state and an unfolded state. As shown in FIG. 1, a folded state diagram of the electronic device protective case is shown, where the two protective cases are parallel to each other and the two protective cases are located at upper and lower ends inside the connecting middle case. The two protective cases are perpendicular to the connecting middle case, and the folded electronic device protective case is small, facilitating storage. As shown in FIG. 2, an unfolded state diagram of the electronic device protective case is shown, where the two protective cases are parallel to the connecting middle case, and at least a portion of each of the two protective cases overlaps with the connecting middle case. The shape of the unfolded electronic device protective case is similar to the shape of a mobile phone in the unfolded mode, enabling flexible use.

Furthermore, the first groove 12 is an elongated oblique slot. During the process of the protective case 10 rotating relative to the connecting middle case 20, the rotating shaft 24 is movable along a length direction of the first groove 12, enabling a larger rotational range and more flexible rotation for the protective case 10.

In this embodiment, the movable clamping arm 22 is connected to one of a left end and a right end of the base plate 32 via an elastic connection assembly 25. Specifically, the movable clamping arm 22 is connected to both left and right ends of the base plate 21 via an elastic connection assembly 25. The two clamping arms 22 can approach or leave each other to adjust the spacing between them. Optionally, the two clamping arms 22 may also adopt a threaded telescopic rod structure, a damped telescopic structure, or a rack-and-pinion transmission telescopic structure from the prior art to achieve spacing adjustment.

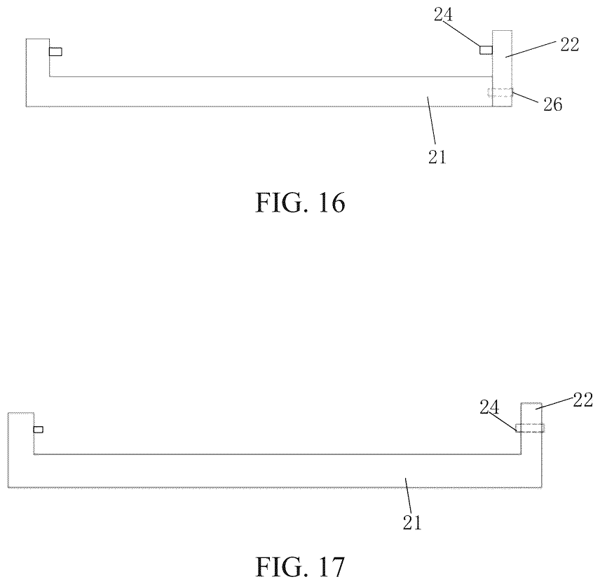

In other embodiments, as shown in FIG. 16, the movable clamping arm 22 is detachably connected to the base plate 21 via a connector 26, for example, the connector 26 is a screw. The clamping arm 22 is detachably mounted on one end of the base plate 21 via the screw. During use, after the electronic device is placed into the protective case 10, the clamping arm 22 is mounted on one end of the base plate 21 via the screw, and the rotating shaft 24 engages with the first groove 12, enabling the assembly and use of the protective case 10. In another embodiment, the movable clamping arm 22 is movably connected to the base plate 21 via a locking assembly 4. The specific implementation of the clamping arm 22 being movably connected to the base plate 21 via the locking assembly 4 is described later and is not elaborated herein.

Optionally, as shown in FIG. 17, the rotating shaft 24 is provided on two side surfaces of the clamping arm 22, and the rotating shaft 24 on at least one of the side surfaces is detachably mounted on the clamping arm 22. As the rotating shaft 24 on at least one side surface of the two side surfaces of the clamping arm 22 is detachable, after the electronic device is placed into the protective case 10, it is mounted onto the clamping arm 22, allowing the rotating shaft 24 to engage with the first groove 12, thus enabling the assembly and use of the protective case 10. For example, the rotating shaft 24 is provided with an external thread, and the clamping arm 22 is provided with a threaded hole. The rotating shaft 24 is screwed into the threaded hole to achieve the purpose of detachably mounting the rotating shaft 24 on the clamping arm 22.

Optionally, the side wall is perpendicularly or approximately perpendicularly disposed on the protective case 10. The side wall is perpendicularly disposed on the protective case 10, meaning the included angle between the side wall and the protective case 10 is 90°. In this application, the side wall is approximately perpendicularly disposed on the protective case 10, meaning the included angle between the side wall and the protective case 10 is 90°+3°.

As shown in FIG. 4, the elastic connection assembly 25 includes at least one connecting rod 251 parallel to the base plate 21; and a telescopic spring 252 sleeves the connecting rod 251. One end of the connecting rod 251 is fixedly connected to the base plate 21, and the other end is movably connected to the clamping arm 22. A free end of the connecting rod 251 is provided with a first limiting portion 253 for preventing the clamping arm 22 from disengaging from the connecting rod 251. The telescopic spring 252 provides an elastic force to the first limiting portion 253 and the clamping arm 22; and the telescopic spring 252 may be disposed between the first limiting portion 253 and the clamping arm 22. When the two clamping arms 22 are simultaneously pulled outward, the telescopic springs 252 on both sides are deformed by compression or extension due to the force applied by the clamping arms, causing the two clamping arms 22 to move in a direction facing away from the length direction of the base plate 21, and increasing the spacing between the two clamping arms 22. When the clamping arms 22 lose external force, the telescopic spring 252 automatically resets and drives the clamping arms 22 toward the base plate 21, reducing the spacing between the two clamping arms 22.

Furthermore, the clamping arm 22 is provided with a movement slot 221 for the connecting rod 251 to pass through and for placing the telescopic spring 252. The telescopic spring 252 can be concealed within the movement slot 221, not only enhancing the aesthetic appearance of the connecting middle case but also protecting the telescopic spring from external environmental influences. A side surface of the movement slot 221 facing the base plate 21 is provided with a limiting surface 222 for preventing the first limiting portion 253 from disengaging from the clamping arm 22 and for supporting the telescopic spring 252. Both ends of the telescopic spring 252 respectively abut against the first limiting portion 253 and the limiting surface 222, ensuring a stable connection.

Optionally, as shown in FIG. 3, a side surface of the base plate 21 facing the clamping space 23 is provided with a second groove 211 recessed inward along the length direction thereof. This provides a certain clearance space for the two protective cases and the foldable phone, not only facilitating flexible folding and rotation of the two protective cases on the connecting middle case, but also ensuring that the central axis of the foldable phone does not contact the connecting middle case when the foldable phone and the electronic device protective case are folded and rotated, effectively preventing scratches to the central axis of the foldable phone.

Furthermore, the base plate 21 is provided with a window 212 communicating with the second groove 211. When the two protective cases are in a folded state, the window 212 helps the user to see the logo on the phone clearly.

Furthermore, two side edges of the side surface of the base plate 21 facing the clamping space 23 are each provided with an eave edge 213. When the two protective cases are unfolded outward to be parallel with the base plate, the multiple eave edges position the two protective cases 10 to maintain a parallel state of the two protective cases 10.

Furthermore, two side walls 11 of at least one protective case 10 are each provided with a second limiting portion 13 parallel to an upper surface of the electronic device. Through the provision of multiple second limiting portions, the electronic device can fit more closely with the protective case. Furthermore, an inner surface of at least one protective case may also be provided with an adhesive surface for adhering to a back surface or a side surface of the electronic device. Through the provision of the adhesive surface, a close fit between the electronic device and the protective case is achieved. The protective case may be provided with only the second limiting portion, only the adhesive surface, or both the second limiting portion and the adhesive surface.

Furthermore, a back surface of any protective case 10 is provided with a support frame 14 for supporting the electronic device. As the support frame is provided, the phone protective case is not only a tool for protecting the phone, but also can serve as a support means for watching videos, enhancing the product's practicality.

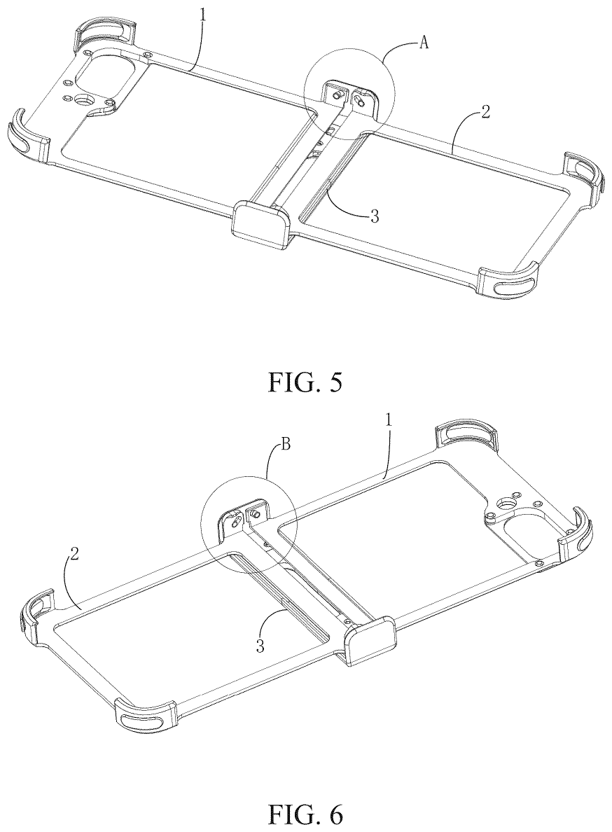

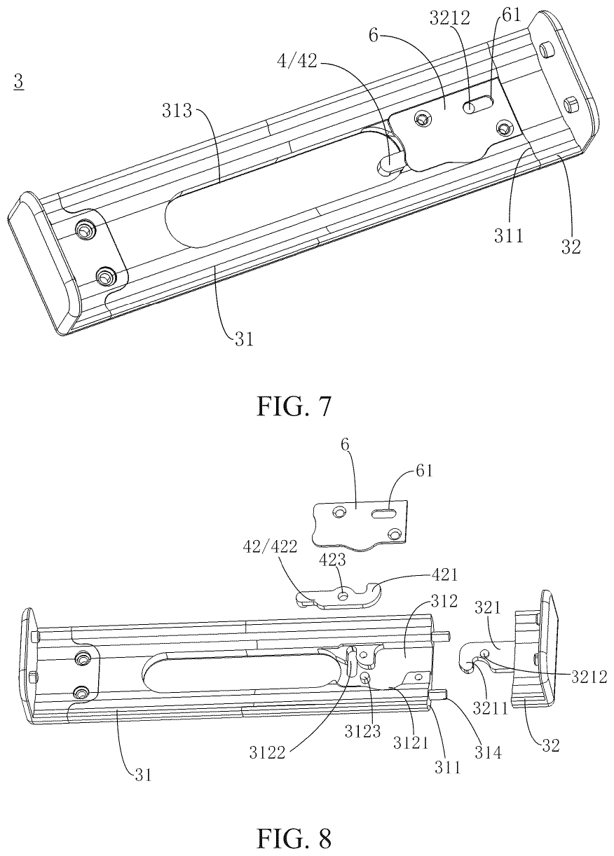

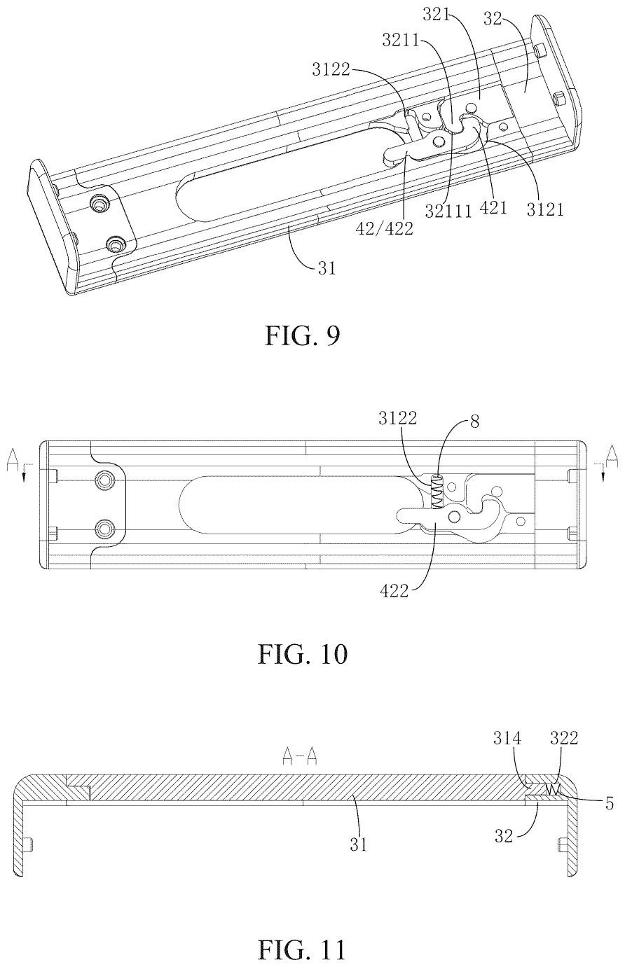

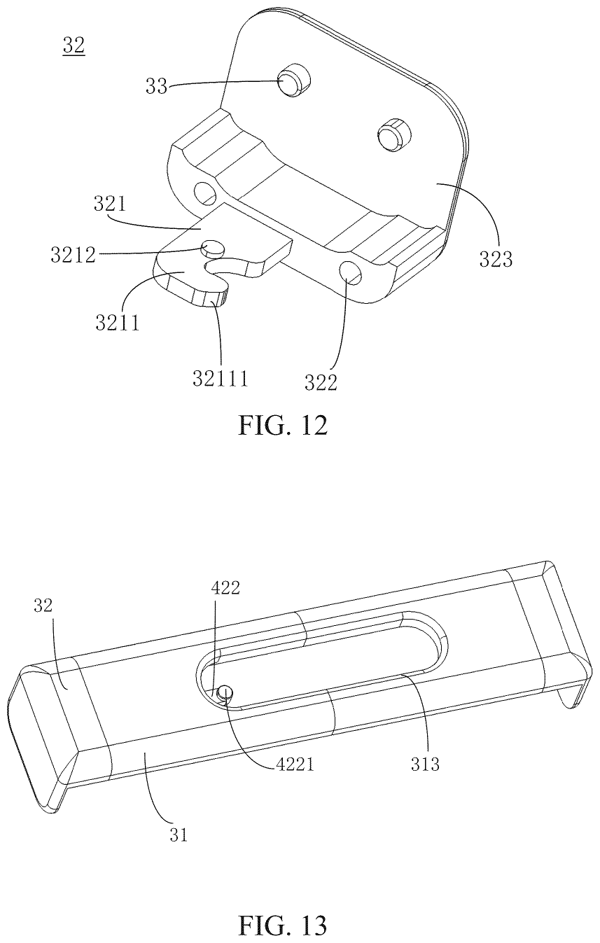

In an optional embodiment, as shown in FIGS. 5 to 12, two protective cases are provided, namely a first protective case 1 and a second protective case 2. The protective case also includes a connecting middle case 3, a locking assembly 4, and a first elastic member 5; an end of the first protective case 1 and an end of the second protective case 2 are both rotatably mounted on the connecting middle case 3, so that the first protective case 1 and the second protective case 2 are rotatable towards each other for folding.

The connecting middle case 3 includes a base plate 31 and a clamping arm 32, and the clamping arm 32 is mounted at a first end 311 of the base plate 31 and is movable to approach and leave the first end 311. The first elastic member 5 is connected to both the first end 311 and the clamping arm 32, and the first elastic member 5 provides an elastic force driving the clamping arm 32 to move in a direction away from the first end 311. The clamping arm 32 is detachably connected to the first protective case 1 and the second protective case 2, and the locking assembly 4 is mounted on the connecting middle case 3 and locks the clamping arm 32.

The locking assembly 4 is driven to unlock the clamping arm 32, causing the clamping arm 32 to move in the direction away from the first end 311 under the elastic force of the first elastic member 5, so that the first protective case 1 and the second protective case 2 are detachable on the connecting middle case 3 after being disconnected from the clamping arm 32.

The protective case of this application includes a first protective case 1, a second protective case 2, and a connecting middle case 3. The first protective case 1 and the second protective case 2 are rotatably mounted via the connecting middle case 3 to form an entirety of the protective case. The connecting middle case 3 is provided with a clamping arm 32, and the clamping arm 32, driven by a first elastic member 5, has a tendency to move in a direction away from a first end 311. In an assembled and used state, a locking assembly 4 locks the clamping arm 32. At this time, the first protective case 1 and the second protective case 2 are mounted on the connecting middle case 3 and are not detachable. After the locking assembly 4 is driven to unlock the clamping arm 32, the clamping arm 32 moves in a direction away from the first end 311 under the elastic force of the first elastic member 5, disconnecting the clamping arm 32 from the first protective case 1 and the second protective case 2. Then, the first protective case 1 and the second protective case 2 can be detached from the connecting middle case 3.

During use, pushing the clamping arm 32 toward the first end 311 causes the locking assembly 4 to lock the clamping arm 32, completing the mounting for use. When detachment from the foldable device is needed, the locking assembly 4 is driven to unlock the clamping arm 32. The clamping arm 32 automatically springs out in a direction away from the first end 311 under the elastic force of the first elastic member 5, allowing the first protective case 1 and the second protective case 2 to be detached, thus making the overall assembly and disassembly simple.

Specifically, the protective case of this application is for a foldable electronic device with a foldable screen, such as a foldable phone, protecting the foldable phone during daily use. In particular, it can be used for a foldable phone with a single foldable screen that folds in a length direction.

During use, a first frame is fastened to a back surface of one folding portion of the foldable phone, and a second frame is fastened to a back surface of another folding portion of the foldable phone.

Specifically, as shown in FIG. 13, the clamping arm 32 is provided with a hook portion 321 having a first hook 3211. The hook portion 321 extends from the first end 311 into a base plate 31, and the locking assembly 4 locks with the hook. Through the provision of a hook portion 321 with a first hook 3211 on the clamping arm 32, which extends from the first end 311 into the base plate 31 and is locked by the locking assembly 4 with the first hook 3211, reliable locking of the clamping arm 32 is achieved. When unlocking is needed, driving the locking assembly 4 releases the lock on the first hook 3211, allowing the clamping arm 32 to move under the elastic force of the first elastic member 5, thus achieving disconnection from the first protective case 1 and the second protective case 2. This enables the protective case to be detached from the connecting middle case 3, facilitating mounting and detachment operations by the user as needed and improving the use convenience and flexibility of the protective case. The hook portion 321 with the first hook 3211 ensures stable locking of the clamping arm 32 and a simple hooking structure.

Furthermore, the locking assembly 4 includes a second elastic member 41 and a hook member 42. One end of the hook member 42 is provided with a second hook 421, and the other end is a driving section 422. The hook member 42 is rotatably mounted on the base plate 31, and the second elastic member 41 is mounted on the base plate 31 and connected to the driving section 422. Under the elastic force of the second elastic member 41, the second hook 421 engages with the first hook 3211 to lock the clamping arm 32. The locking assembly 4 includes the second elastic member 41 and the hook member 42. The second hook 421 at one end of the hook member 42 engages with the first hook 3211 under the elastic force of the second elastic member 41, thereby locking the clamping arm 32. When the clamping arm 32 is pushed to a predetermined locking position, under the elastic force of the second elastic member 41, the hook member 42 automatically rotates to reset, causing the second hook 421 to engage with the first hook 3211 without requiring additional operation steps, thus simplifying the operation process of the user. At the same time, the locking is stable and reliable, ensuring that the clamping arm 32 does not loosen unexpectedly during normal use, and maintaining the overall structural stability of the protective case and effectively protecting the foldable electronic device.

An outer end surface of an end of the first hook 3211 is arranged as an inclined surface 32111. Thus, when the clamping arm 32 is pushed toward the first end 311, the inclined surface 32111 pushes the hook member 42 to rotate and avoid the first hook 3211, achieving automatic engagement between the first hook 3211 and the second hook 421.

The base plate 31 is provided with a mounting slot 312 near one end, and the mounting slot 312 opens at the first end 311. The hook portion 321 is inserted into the mounting slot through the opening, the hook member 42 is rotatably mounted in the mounting slot 312, and the second elastic member 41 is mounted in the mounting slot 312. A mounting slot 312 is provided in the base plate 31, and the mounting slot 312 opens at the first end 311. The hook portion 321 is inserted into the mounting slot 312 through the opening, the hook member 42 is rotatably mounted in the mounting slot 312, and the second elastic member 41 is also mounted in the mounting slot 312. Through such provision, each component can be compactly mounted on the connecting middle case 3, reducing space occupation and making the structure of the connecting middle case 3 more compact and reasonable. At the same time, the opening of the mounting slot 312 facilitates the insertion and mounting of the hook portion 321. Additionally, mounting the hook member 42 and the second elastic member 41 within the mounting slot 312 helps to enhance the mounting stability of the hook member 42 and the second elastic member 41.

Specifically, the hook member 42 is provided with a second rotation mounting hole 423, and the mounting slot 312 is provided with a rotation mounting post 3123. The second rotation mounting hole 423 is rotatably mounted in the rotation mounting post 3123, achieving the rotational mounting of the hook member 42. As shown in FIG. 10, within the mounting slot 312, the first hook 3211 and the second hook 421 are correspondingly arranged and engage with each other during locking.

The hook member 42 extends along a length direction of the base plate 31, and the mounting slot 312 includes an avoidance slot 3121 and a limiting slot 3122. The avoidance slot 3121 is provided corresponding to the second hook 421 on a side of the second hook 421 facing away from the first hook 3211. The limiting slot 3122 is located on an inner side of the mounting slot 312 opposite the avoidance slot 3121, the limiting slot 3122 is disposed corresponding to the driving section 422, and the second elastic member 41 is mounted in the limiting slot 3122. The avoidance slot 3121 provides rotational space for the second hook 421 during the rotation of the hook member 42, ensuring normal rotation of the second hook 421. The limiting slot 3122 limits the second elastic member 41, enabling stable mounting at a predetermined position, and ensuring that the elastic force of the second elastic member 41 on the hook member 42 is stable and reliable, thus ensuring the accuracy and stability of locking and unlocking actions and further improving the performance and reliability of the protective case. The shape and size of the limiting slot 3122 can be adapted to the second elastic member 41, and the shape of the avoidance slot 3121 can be adapted to the shape of the second hook 421, with no specific restrictions herein.

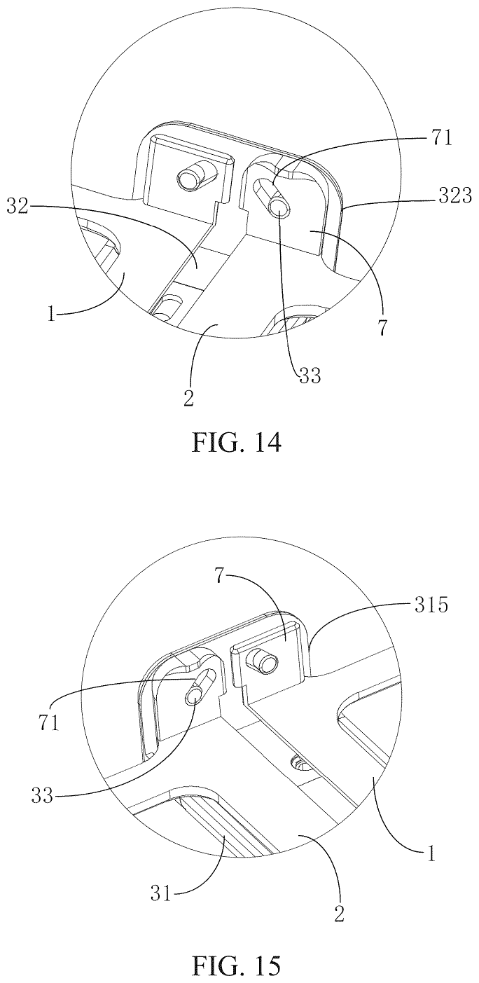

As further shown in FIG. 14, the base plate 31 is provided with an obround slot 313, and the driving section 422 extends to the obround slot 313. A protruding portion 4221 is provided on a side of an end portion of the driving section 422 facing the obround slot 313. The user can easily touch the protruding portion 4221 of the driving section 422 through the obround slot 313, facilitating the application of external force to rotate the hook member 42 and achieve the unlocking operation. As the protruding portion 4221 is provided, friction and leverage points are increased, enabling the user to operate more easily without additional tools, thus improving operational convenience and user experience. At the same time, the design of the obround slot 313 does not significantly affect the overall structural strength of the connecting middle case 3, ensuring the stability and reliability of the connecting middle case 3 and maintaining the structural integrity of the protective case during use. During operation, the user pushes the protruding portion 4221 with a finger, driving the hook member 42 to rotate, and causing the second hook 421 to disengage from the first hook 3211, thereby unlocking the clamping arm 32. The clamping arm 32 automatically springs out in a direction away from the first end 311 under the elastic force of the first elastic member 5, releasing the restriction on the first protective case 1 and the second protective case 2, and placing them in a detachable state. The obround slot 313 can be configured as an elongated shape, with the driving section 422 extending from one end of the obround slot 313 to be exposed at the obround slot 313, allowing the user to push the protruding portion 4221.

The mounting slot 312 is covered with a pressure plate 6, and the pressure plate 6 is provided with a stroke limiting hole 61, the stroke limiting hole 61 extending in the movement direction of the clamping arm 32. The hook portion 321 is provided with a stroke limiting protrusion post 3212, and the stroke limiting protrusion post 3212 is embedded in the stroke limiting hole 61. When the clamping arm 32 moves to a maximum stroke distance in the direction away from the first end 311, the stroke limiting protrusion post 3212 abuts against an end of the stroke limiting hole 61 closer to the clamping arm 32. The pressure plate 6 facilitates stable mounting of the hook member 42, a second spring, and the hook portion 321 in the mounting slot 312. The pressure plate 6 can be fixed to the connecting middle case 3 by riveting or screw fixation, which are conventional technical means and are not elaborated herein. The pressure plate 6 is provided with a stroke limiting hole 61. When the clamping arm 32 moves to a maximum stroke distance in the direction away from the first end 311, the stroke limiting protrusion post 3212 abuts against an end of the stroke limiting hole 61 closer to the clamping arm 32. Through the limiting of the stroke limiting hole 61, the movement range of the clamping arm 32 can be precisely controlled, preventing the clamping arm 32 from overextending and disengaging from the first end 311. At the same time, the pressure plate 6 further protects the components within the mounting slot 312, preventing dust and debris from entering the mounting slot 312 and affecting the normal operation of the components, while also maintaining the clean appearance of the connecting middle case 3, improving the overall quality and aesthetics of the product.

The first end 311 is provided with a first insertion post 314, and the clamping arm 32 is provided with an insertion hole 322 corresponding to the first insertion post 314. The first insertion post 314 is inserted into the corresponding insertion hole 322. The first elastic member 5 is a spring, the first elastic member 5 is mounted in the insertion hole 322, and the first elastic member 5 is connected to the first insertion post 314. When the locking assembly 4 locks the clamping arm 32, the first elastic member 5 is compressed. Specifically, both sides of the first end 311 are provided with a first insertion post 314, and the insertion holes 322 are correspondingly provided. The first elastic member 5 is mounted in each insertion hole 322.

Through the provision of the first insertion post 314 and the insertion hole 322, the connection between the clamping arm 32 and the base plate 31 is more stable and reliable. The engagement of the first insertion post 314 and the insertion hole 322 provides guidance for the movement of the clamping arm 32, ensuring smooth movement of the clamping arm 32 along a predetermined direction. When the locking assembly 4 locks the clamping arm 32, the first elastic member 5 is compressed, storing elastic potential energy. Once unlocked, the clamping arm 32 can quickly and automatically move in a direction away from the first end 311 under the elastic force of the first elastic member 5, achieving disconnection from the first protective case 1 and the second protective case 2, making the operation simple and quick, and improving the detachment efficiency of the protective case. Additionally, as a spring, the first elastic member 5 has good elasticity and stability, providing stable elastic force over the long term, thus ensuring the normal operation of the clamping arm 32. The first elastic member 5 can be stably mounted in the insertion hole 322. The connection of the first elastic member 5 to the insertion post can either be one end of the first elastic member 5 fixedly mounted on the insertion post or one end of the first elastic member 5 abutting against the insertion post, as long as the first elastic member 5 can provide elastic force between the first insertion post 314 and the insertion hole 322, with no specific restrictions herein.

As further shown in FIGS. 14 and 15, an end of the clamping arm 32 away from the base plate 31 is provided with a first mounting plate 323, and an end of the base plate 31 away from the clamping arm 32 is provided with a second mounting plate 315 opposite the first mounting plate 323. An inner side surface of each of the first mounting plate 323 and the second mounting plate 315 is provided with two limiting posts 33. An end of the first protective case 1 and the second protective case 2 mounted on the connecting middle case 3 is provided with a third mounting plate 7 on both sides. The third mounting plate 7 is provided with a first rotation mounting hole 71, and the first rotation mounting holes 71 can be rotatably mounted in the corresponding limiting posts 33. Through the engagement of the limiting post 33 and the first rotation mounting hole 71, the first protective case 1 and the second protective case 2 can be stably mounted on the connecting middle case 3 and can achieve relative rotation to accommodate the folding and unfolding operations of the foldable electronic device.

The first rotation mounting holes 71 are all elongated, and in an unfolded state of the first protective case 1 and the second protective case 2, and between two adjacent first rotation mounting holes 71 in the first protective case 1 and the second protective case 2, ends of the two first rotation mounting holes 71 close to a side where the first end 311 is located are relatively far apart, and ends of the two first rotation mounting holes 71 away from the side where the first end 311 is located are relatively close, so that the two adjacent first rotation mounting holes 71 are disposed in a shape of a Chinese character of “ [symbol] ”.

In this solution, the first rotation mounting holes 71 are elongated, as shown in FIGS. 5, 15, and 16, and in an unfolded state of the first protective case 1 and the second protective case 2, and between two adjacent first rotation mounting holes 71 in the first protective case 1 and the second protective case 2, ends of the two first rotation mounting holes 71 close to a side where the first end 311 is located are relatively far apart, and ends of the two first rotation mounting holes 71 away from the side where the first end 311 is located are relatively close, showing the shape of “ [symbol] ”. In this way, the first protective case 1 and the second protective case 2 can better adapt to folding angle changes of a foldable electronic device during rotation, providing more flexible rotational performance. When the foldable electronic device is subjected to a folding or unfolding operation, the first protective case 1 and the second protective case 2 can adjust their rotation based on the shape changes of the device, ensuring smooth rotation.

Specifically, during use of the protective case of this application, in one method of use, the first protective case 1 and the second protective case 2 are first fastened to the back surfaces of two folding portions of a single-fold screen foldable phone. Then, two limiting posts 33 on the second mounting plate 315 are inserted into the first rotation mounting holes 71 of the corresponding third mounting plates 7 on the first protective case 1 and the second protective case 2. Next, the clamping arm 32 in an unlocked state is pushed toward the first end 311, compressing the first elastic member 5. The first hook 3211 engages and locks with the second hook 421, and simultaneously, the two limiting posts 33 on the second mounting plate 315 are inserted into the first rotation mounting holes 71 of the corresponding third mounting plates 7 on the first protective case 1 and the second protective case 2, completing the assembly for use. At this time, both the first protective case 1 and the second protective case 2 can rotate following the corresponding folding portions of the foldable phone.

When the protective case is detached from the foldable phone, pushing the protruding portion 4221 drives the hook member 42 to rotate, compressing the second elastic member 41. The second hook 421 disengages from the first hook 3211, thereby unlocking the clamping arm 32. The clamping arm automatically springs out in a direction away from the first end 311 under the elastic force of the first elastic member 5. The two limiting posts 33 on the second mounting plate 315 disengage from the first rotation mounting holes 71 of the corresponding third mounting plates 7 on the first protective case 1 and the second protective case 2, releasing the restriction on the first protective case 1 and the second protective case 2, and allowing the first protective case 1 and the second protective case 2 to be detached from the foldable phone.

It should be understood that those skilled in the art can make improvements or variations based on the above description, and all such improvements and variations shall fall within the protection scope of the claims appended to this application.

What is claimed is:

1. An electronic device protective case for a foldable electronic device, comprising at least two protective cases, with a connecting middle case disposed between adjacent two of the protective cases, wherein the connecting middle case comprises a base plate and two clamping arms; the base plate and the two clamping arms enclose a clamping space for clamping the two protective cases; two sides of each of the two protective cases are respectively provided with side walls cooperatively connected with the two clamping arms; and on two opposite side surfaces of the side wall and the clamping arm, one surface is convexly provided with a rotating shaft, and the other surface is provided with a first groove cooperatively engaged with the rotating shaft; wherein
the first groove corresponding to at least one of the protective cases is an elongated oblique slot, and during a process of the protective case rotating relative to the connecting middle case, the rotating shaft is movable along a length direction of the first groove.

2. The electronic device protective case according to claim 1, wherein the side wall is perpendicularly or approximately perpendicularly disposed on the protective case.

3. The electronic device protective case according to claim 1, wherein at least one clamping arm of the two clamping arms is movably connected to the base plate; and a spacing between the two clamping arms is adjustable.

4. The electronic device protective case according to claim 3, wherein the movable clamping arm is connected to one of a left end and a right end of the base plate via an elastic connection assembly; or
the movable clamping arm is detachably connected to the base plate via a connector; or
the movable clamping arm is movably connected to the base plate via a locking assembly.

5. The electronic device protective case according to claim 1, wherein the rotating shaft is disposed on two side surfaces of the clamping arms, and the rotating shaft on at least one of the side surfaces is detachably mounted on the clamping arm.

6. The electronic device protective case according to claim 4, wherein the elastic connection assembly comprises at least one connecting rod parallel to the base plate and a telescopic spring sleeving the connecting rod; one end of the connecting rod is fixedly connected to the base plate, and the other end is movably connected to the clamping arm; and a free end of the connecting rod is provided with a first limiting portion for preventing the clamping arm from disengaging from the connecting rod, and the telescopic spring provides an elastic force to the first limiting portion and the clamping arm.

7. The electronic device protective case according to claim 6, wherein the clamping arm is provided with a movement slot for the connecting rod to pass through and for placing the telescopic spring; a side surface of the movement slot facing the base plate is provided with a limiting surface for preventing the first limiting portion from disengaging from the clamping arm and for supporting the telescopic spring; and two ends of the telescopic spring respectively abut against the first limiting portion and the limiting surface.

8. The electronic device protective case according to claim 1, wherein a side surface of the base plate facing the clamping space is provided with a second groove recessed inward along a length direction thereof.

9. The electronic device protective case according to claim 8, wherein two side edges of the side surface of the base plate facing the clamping space are each provided with an eave edge for positioning the two protective cases, keeping the two parallel.

10. The electronic device protective case according to claim 1, wherein two side walls of at least one of the protective cases are each provided with a second limiting portion parallel to an upper surface of an electronic device; and/or
an inner surface of at least one of the protective cases is provided with an adhesive surface for adhering to a back surface or a side surface of the electronic device.

11. A protective case for a foldable electronic device, comprising a first protective case, a second protective case, a connecting middle case, a locking assembly, and a first elastic member, wherein an end of the first protective case and an end of the second protective case are both rotatably mounted on the connecting middle case, so that the first protective case and the second protective case are rotatable towards each other for folding;
the connecting middle case comprises a base plate and a clamping arm, and the clamping arm is mounted at a first end of the base plate and is movable to approach and leave the first end; the first elastic member is connected to both the first end and the clamping arm, and the first elastic member provides an elastic force driving the clamping arm to move in a direction away from the first end; the clamping arm is detachably connected to the first protective case and the second protective case; and the locking assembly is mounted on the connecting middle case and locks the clamping arm; and
the locking assembly is driven to unlock the clamping arm, causing the clamping arm to move in the direction away from the first end under the elastic force of the first elastic member, so that the first protective case and the second protective case are detachable on the connecting middle case after disconnected from the clamping arm.

12. The protective case according to claim 11, wherein the clamping arm is provided with a hook portion having a first hook, the hook portion extends from the first end into the base plate, and the locking assembly locks with the hook portion.

13. The protective case according to claim 12, wherein the locking assembly comprises a second elastic member and a hook member, one end of the hook member is provided with a second hook, and the other end is a driving section; the hook member is rotatably mounted on the base plate, and the second elastic member is mounted on the base plate and is connected to the driving section; and under the elastic force drive of the second elastic member, the second hook engages with the first hook to lock the clamping arm.

14. The protective case according to claim 13, wherein the base plate is provided with a mounting slot near the one end, and the mounting slot has an opening at the first end; and the hook portion is inserted into the mounting slot from the opening, the hook member is rotatably mounted in the mounting slot, and the second elastic member is mounted in the mounting slot.

15. The protective case according to claim 14, wherein the hook member extends along a length direction of the base plate, and the mounting slot comprises an avoidance slot and a limiting slot; the avoidance slot is provided corresponding to the second hook on a side of the second hook facing away from the first hook; the limiting slot is located on one side in the mounting slot opposite to the avoidance slot, the limiting slot is provided corresponding to the driving section, and the second elastic member is mounted in the limiting slot.

16. The protective case according to claim 13, wherein the base plate is provided with an obround slot, and the driving section extends to the obround slot; a side of the driving section facing the obround slot is provided with a protruding portion; and/or an outer end surface of an end of the first hook is arranged as an inclined surface.

17. The protective case according to claim 14, wherein the mounting slot is covered with a pressure plate, the pressure plate is provided with a stroke limiting hole, the stroke limiting hole extends in a movement direction of the clamping arm, the hook portion is provided with a stroke limiting protrusion post, and the stroke limiting protrusion post is embedded in the stroke limiting hole; and
when the clamping arm moves to a maximum stroke in the direction away from the first end, the stroke limiting protrusion post abuts against an end of the stroke limiting hole close to the clamping arm.

18. The protective case according to claim 11, wherein the first end is provided with a first insertion post, the clamping arm is provided with an insertion hole corresponding to the first insertion post, and the first insertion post is inserted into the corresponding insertion hole; and
the first elastic member is a spring, the first elastic member is mounted in the insertion hole, and the first elastic member is connected to the first insertion post; and when the locking assembly locks the clamping arm, the first elastic member is compressed.

19. The protective case according to claim 18, wherein an end of the clamping arm away from the base plate is provided with a first mounting plate, an end of the base plate away from the clamping arm is provided with a second mounting plate opposite to the first mounting plate, and an inner side surface of each of the first mounting plate and the second mounting plate is provided with two limiting posts; and
an end of the first protective case and the second protective case mounted on the connecting middle case is provided with a third mounting plate on both sides, the third mounting plate is provided with a first rotation mounting hole, and the first rotation mounting holes are rotatably mountable on the corresponding limiting posts respectively.

20. The protective case according to claim 19, wherein the first rotation mounting holes are all elongated, and in an unfolded state of the first protective case and the second protective case, and between two adjacent first rotation mounting holes in the first protective case and the second protective case, ends of the two first rotation mounting holes close to a side where the first end is located are relatively far apart, and ends of the two first rotation mounting holes away from the side where the first end is located are relatively close, so that the two adjacent first rotation mounting holes are disposed in an shape of a Chinese character of “ [symbol] ”.
